(19) United States
(12) Patent Application Publication
(10) Pub. No.: US 2015/0154097 A1
(43) Pub. Date: Jun. 4, 2015

(54) SYSTEM AND METHOD FOR AUTOMATED TESTING

(71) Applicants: Dawid Walenty Duda, Zielonki (PL); Jeffrey Thomas Pascoe, Farmington, MI (US); Krzysztof Maziarz, Krakow (PL)

(72) Inventors: Dawid Walenty Duda, Zielonki (PL); Jeffrey Thomas Pascoe, Farmington, MI (US); Krzysztof Maziarz, Krakow (PL)

(73) Assignee: COMPACT SOLUTIONS, LLC, Oakbrook Terrace, IL (US)

(21) Appl. No.: 14/046,948

(22) Filed: Oct. 5, 2013

Related U.S. Application Data
(60) Provisional application No. 61/710,623, filed on Oct. 5, 2012.

(51) Int. Cl. G06F 11/36

(52) U.S. Cl. CPC G06F 11/3608; G06F 11/3664

(57) ABSTRACT

The present invention relates to a system and method for testing software. More particularly, the present invention relates to a system for running automated validation simulations across a variety of software programs including data integration applications in particular. The unique process presented herein allows to significantly reduce the amount of manual work related to preparing, running, and verifying the tests of data integration applications.

### FIELD OF INVENTION

The present invention relates to a system and method for testing software. More particularly, the present invention relates to a system for running automated validation simulations across a variety of software programs including data integration applications in particular.

### SUMMARY AND BACKGROUND OF INVENTION

Testing of complex software applications is a time consuming process, particularly when such testing is done manually. There is a need for a system that can perform the tests quickly and automatically, minimizing the possibility for errors and delays associated with manual execution.

Data Integration applications or processes in particular are specialized computer programs that perform data movement and transformations between data assets like databases, data files etc. Those processes can be implemented using multiple different technologies, like SQL scripts, database vendor specific load/unload tools, specialized ETL (Extract, Transform, Load) products or custom built programs implemented in any programming language. Regardless of the implementation method, data integration applications, like any other piece of computer software, need proper testing including verification, validation and tracing.

The challenges faced with the testing of data integration applications in particular are especially onerous due to their ever-increasing level of complexity and abstraction, warranting a dedicated solution. Automation of this process dramatically improves the speed, accuracy, repeatability and reliability of the testing. These benefits become apparent with testing data integration applications. This is because the time allotted for such tasks is often very limited and/or delegated to individuals who are not familiar with the details of the data storage or formatting. The time necessary to manually accomplish the testing portions thus often ends up taking substantially longer than it should or is given less attention than it requires.

Testing a data integration application generally requires the following steps:
1. Prepare the test environment by making sure that the application that will be tested is correctly deployed;
2. Deliver input data in proper format and locations so that the data integration process will be able to read it;
3. Trigger execution of the application; and
4. Verify that the results are correct by either comparing them with expected results or performing other manual or automatic checks that will confirm that the results are correct or point to some issues.

Under previous systems, most of these tasks are performed manually and are prone to errors. Additionally, once the steps have been accomplished, any detected errors must be reviewed, and the source of the error located and corrected. The process must then be repeated in successive iterations until all errors are located and corrected. Not surprisingly, this method is very inefficient, and requires a large amount of time and labor.

The present invention comprises a process that may incorporate the testing portion into the earlier design stages. Such a structure enables a wide variety of later tasks to be easily and reliably accomplished with minimal effort and human interaction. The system is oriented specifically toward the testing of data integration and related operations. This is why it offers many features and advantages not possible in general testing systems.

The present invention specifically contemplates executable specifications. With other approaches people may rely on central documents or instructions that describe the test cases, but such are merely guidelines. Testers can and often do accomplish identical tasks in a variety of different ways, sometimes deviating greatly from one another. Instructions may be unclear or ambiguous or misunderstood, and testers may modify or omit one or more of the steps.

The present invention automates a significant part of the testing process and thus allows the testers to focus on the critical aspects and higher level tasks like planning, guiding and defining the test cases rather than performing each of the individual constituent steps manually.

### BRIEF DESCRIPTION OF THE DRAWINGS

The detailed description particularly refers to the accompanying figures in which:

FIG. 1 is an overview of the system architecture process according to an embodiment of the invention disclosed herein;

FIG. 2 is an overview of the system capabilities including the operational inputs and outputs according to an embodiment of the invention disclosed herein

FIG. 3 shows a user interface of the system according to an embodiment of the invention disclosed herein

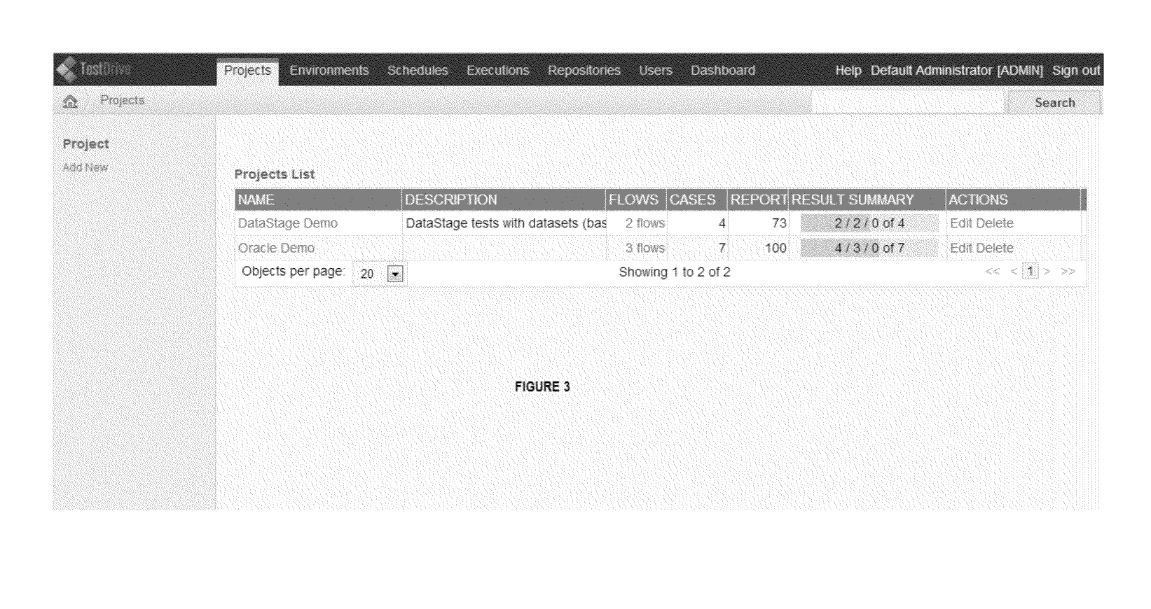

### DETAILED DESCRIPTION OF THE DRAWINGS

The invention comprises a centralized repository of executable test case specifications. Under this arrangement, information provided by the user about the application being tested and the test case or data is stored and managed in a central location. Based upon request or schedule and with little or no additional human input, the system can automatically execute a particular test, analyze the results, provide a detailed report of the identified defects.

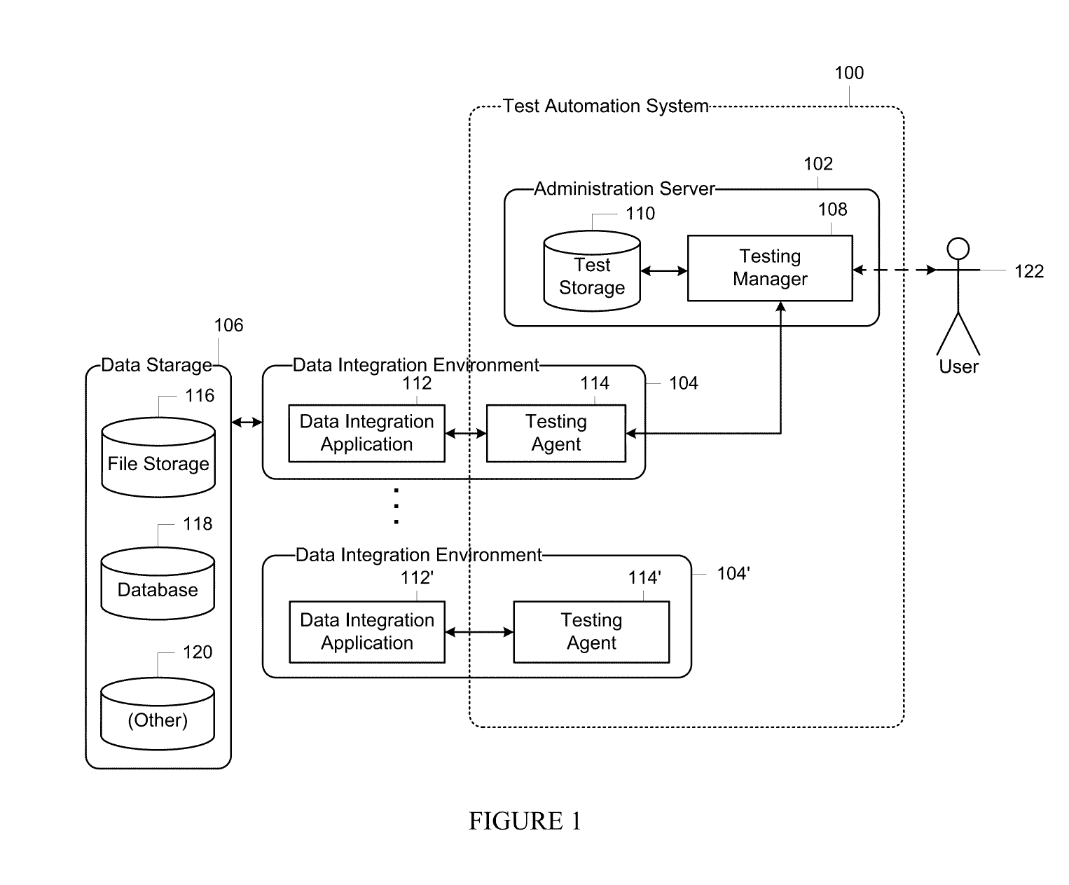

As shown in FIG. 1, the Test Automation System 100 comprises an Administration Server 102, one or more Data Integration Environments 104 . . . 104′, and one or more Data Storage Environments 106.

The Administration Server 102 comprises a Testing Manager 108 that facilitates the creation, management, and monitoring of test definitions, test case data, and test executions. The Administration Server 102 also comprises a central Test Storage 110 that contains all of the metadata describing test definitions, stores the test case data, and stores the historical reports of previously executed tests.

Each distinct Data Integration Environment 104 . . . 104′ comprises a corresponding Data Integration Application 112 . . . 112′ as well as a Testing Agent 114 . . . 114′.

These distinct Data Integration Environments 104 . . . 104′ communicate with a Data Storage 106, which may contain File Storage 116, Database Storage 118, or Other 120 types of data storage (e.g. queues, cubes, etc . . . ). Multiple Data Integration Environments 104 . . . 104′ may share the same Data Storage 106, or each individual Data Integration Environment 104 . . . 104′ may be configured to have separate non-shared Data Storage 106.

From the Administration Server 102, a User 122 can input any testing parameter/definitions as well as the timing/scheduling of the tests to be executed.

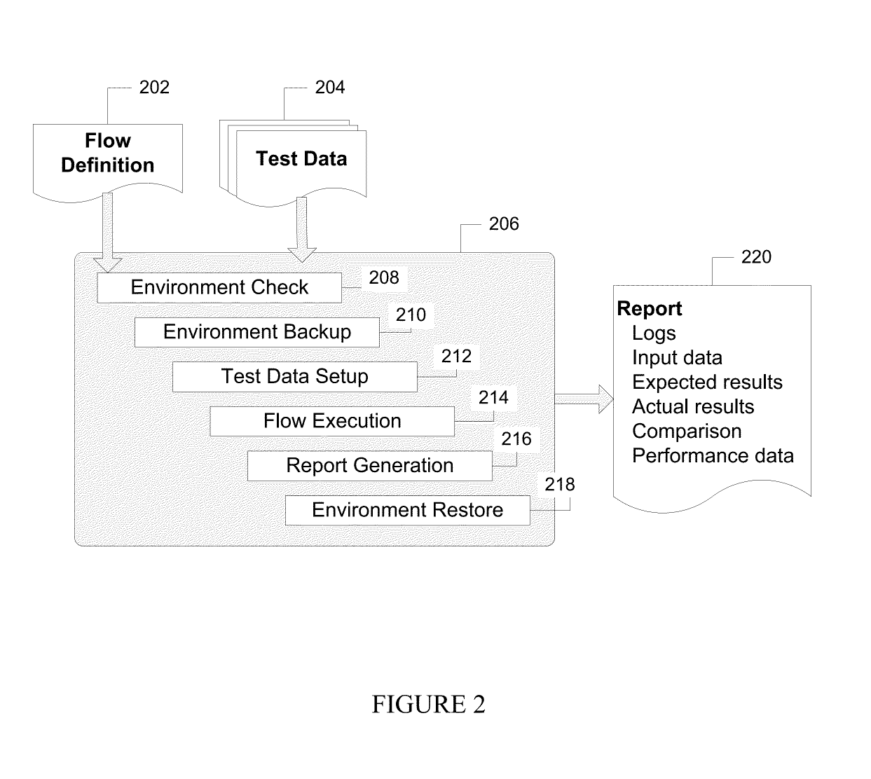

The Administration Server 102 communicates with each of the Data Integration Environments 104 . . . 104′ via their respective Testing Agent 114 . . . 114′ to perform all of the steps related to and required for testing the application represented by the Data Integration Application 112 . . . 112′. The specific details of these steps are described in detail below and in FIG. 2.

The system's single central Testing Manager 108 provides a convenient and reliable testing solution for simultaneous implementations across multiple Data Integration Environments 104 . . . 104′. For instance, a set of tests can be prepared in a development environment and then executed in an integration and/or QA environments. Similarly, tests prepared for one implementation (e.g. SQL scripts) can be used to verify the same logic migrated to another platform (e.g. ETL platforms).

Turning to FIG. 2, an overview of the system capabilities shows what inputs and outputs may be utilized as well what internal tasks the system is capable of automating. Specifically, a number of implementations will be described below by way of example and with respect to testing data integration applications. As the skilled reader realizes, these examples are not intended to be exhaustive. On the contrary, the techniques and tools that will be described below can be used to test a wide variety of applications, such as SQL scripts, ETL programs and others.

The system requires a Flow Definition 202 as an input, which contains information describing what will be tested. This may include specifications of the inputs and outputs to the application being tested, as well as the steps required to execute the application. It also requires Test Data 204 that may include the input data for some or all of the inputs to the application to be tested as well as a method to verify some or all of the outputs of the tested application. As example this may include reference output data for a direct comparison, or logic that can be performed against the input data to create reference data for output comparison, or any other mechanisms to verify the outputs of the application.

The Flow Definition 202 and the Test Data 204 may be stored in the central Test Storage 110 of the Administration Server 102 in FIG. 1.

Based on this limited information, the system is able to accomplish a wide variety of tasks to ensure that the desired output is achieved or determine that it has not been achieved. These inputs comprise executable specifications or simulations which advantageously may be stored and reused multiple times.

In some implementations, the inputs may be automatically generated based on the data integration process being tested or based on previous tests/settings or using the data that is already in place in the environment that it will be executed. Such a feature allows the user to significantly reduce the time needed to prepare the required set of tests.

The present system may optionally use a scheduling system that allows one to automatically execute a given set of tests (that can be either pre-configured or automatically calculated based on list of recently modified application elements). When executed, the system may run one or more tests and may even automatically notify selected recipients of the results.

Based on the Flow Definition 202 and the Test Data 204 the system will perform a process 206 that will contain a set of generated execution steps. These steps may include one or more of the following steps:
Environment Check 208
Environment Backup 210
Test Data Setup 212
Flow Execution 214
Report Generation 216
Environment Restore 218

An Environment Check 208 step may be initially run to verify that the environment is complete and ready for testing (e.g. that the tables/files exist, the permissions are correctly set, and the applications or commands to be executed exist and/or can be executed, etc.). The advantage of this step is to ensure that any missing or improperly configured or prepared elements of the application to be tested are identified at the moment of scheduling the test and not several hours later.

An Environment Backup 210 step may also be automatically performed so as to be able to recover from any changes, loss or damage caused by the execution of the test. This may be accomplished for selected inputs or outputs and facilitates the Environment Restore 218 step discussed below. This is especially useful for shared environments used by multiple people/teams and may optionally compress the backup data to save space.

The Test Data Setup 212 step is likewise automatically performed and may optionally convert the Test Data 204 between formats that are easy to work with for the users (e.g. excel) into other formats that are not easy to work with for the users but are required by the application being tested (e.g. binary files, database tables, etc . . . ). It may also deliver the Test Data 204 to the physical location that is required by the application as specified in the Flow Definition 202. An advantage of this approach is that this conversion and delivery occur automatically, therefore the users can focus on data content and ignore formatting and syntax concerns as well as the required physical location of the input data to be used by the application that is tested.

The Flow Execution 214 step typically requires substantial time, effort and repetitive error-prone manual entry of commands to execute. The present invention performs such a task automatically. During the execution it may gather all additional existing information such as operational metadata, standard error, standard output, exit code, resource usage, etc.

The Report Generation 216 step may generate a comprehensive report with detailed information about all of the above including any issues identified. This Report Generation 216 step may also include the verification of the results—whereby the results of any output datasets specified in the Flow Description 202 are verified by the method specified in the Test Data 204 to verify some or all of the outputs of the tested application. The results verification can be implemented using many alternative methods. Some possible methods include:
1. Comparison with expected results defined for instance as data delivered in Test Data 204, external file, database table, SQL query or other data sources pointed to by Test Data 204.
2. Custom verification logic provided by the user, implemented using the technology of his choice, as specified in the Test Data 204.
3. List of logical conditions that must be met by the results of the process being tested. Those conditions, as specified in the Test Data 204, can be implemented, for instance, using a dedicated assertions language.

The generated Report 220 is stored in the central Test Storage 110 of the Administration Server 102 in FIG. 1. This Report 220 may contain known testing input and output information that may be selected for storage, such as: test configuration, test definitions, input data, actual output data, expected reference output data, error codes, exit status, operational metadata, etc. All this information can be reused or referred to in the future to repeat or trace any particular test or task as well as examine previous results.

The system may also perform an Environment Restore 218 step, resetting the environments or platforms to their original states as captured in the Environment Backup 210 step. This is especially useful for shared environments used by multiple people/teams and may optionally compress the backup data to save space.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by any appended claims.

A plurality of advantages arises from the various features of the present disclosure. It will be noted that alternative embodiments of various components of the disclosure may not include all of the features described yet still benefit from at least some of the advantages of such features. Those of ordinary skill in the art may readily devise their own implementations of a data integration process or application that incorporate one or more of the features of the present disclosure and fall within the spirit and scope of the disclosure.

1. A computer-readable medium operable on a processing unit containing one or more instructions for automatically analyzing and testing data integration applications, the instructions comprising:
reading test specifications of a data integration application, the test specifications comprising a test environment configuration, a set of execution commands, and one or more of an input dataset and an output dataset,
verifying the test environment using metadata from the test specifications;
generating a test operation based on the test specifications;
executing the test operation to yield test results;
verifying the test results by comparing to one or more verification criteria;
generating a detailed report; and
once initiated, said instructions operate automatically without operator intervention.

2. The computer readable medium of claim 1, wherein the test operation step transforms the input data provided in the test specifications to the format and location required for the data integration application.

3. The computer readable medium of claim 1, wherein executing the test operation step invokes the set of execution commands to yield the test results.

4. The computer readable medium of claim 1, wherein generating the test operation further comprises creating a backup of one or more of the datasets;
and wherein the instructions further comprise restoring the datasets from the backup.

5. The computer readable medium of claim 1, wherein the one or more verification criteria are automatically determined based on the test specifications.

6. The computer readable medium of claim 1, wherein the instructions comprise communicating the detailed report to a recipient.

7. A method for analyzing and testing data integration applications, comprising at least one processor to perform a process on a computer readable medium, the process comprising:
reading test specifications of a data integration application, the test specifications comprising a set of execution commands and one or more of an input dataset and an output dataset;
generating a test operation based on the test specifications;
executing the test operation to yield test results;
wherein executing the test operation step invokes the set of execution commands to yield the test results;
verifying the test results by comparing to one or more verification criteria;
generating a detailed report.

8. The method of claim 7, wherein the process further comprise verifying the test environment using the test specifications.

9. The method of claim 7, wherein generating the test operation further comprises creating a backup of one or more of the datasets;
and wherein the process further comprises restoring the datasets from the backup.

10. The method of claim 7, wherein the one or more verification criteria are automatically determined based on the test specifications.

11. The method of claim 7, wherein the process comprising communicating the detailed report to a recipient.

12. A computer program product for automatically analyzing and testing data integration applications, the product being stored in a non-transitory storage medium and having instructions which, when executed by a processor, result in:
reading test specifications of a data integration application, the test specification comprising a test environment configuration, a set of execution commands, and one or more of an input dataset and an output dataset,
verifying the test environment using metadata from the test specifications;
generating a test operation based on the test specifications;
executing the test operation to yield test results; and
generating a detailed report.

13. The computer program of claim 12, wherein the instructions further comprising verifying the test results by comparing to one or more verification criteria.

14. The computer program of claim 12, wherein once initiated, said instructions operate automatically without operator intervention.

15. The computer program of claim 12, wherein executing the test operation step invokes the set of execution commands to yield the test results.

16. The computer program of claim 12, wherein generating the test operation further comprises creating a backup of one or more of the datasets;
and wherein the instructions further comprise restoring the datasets from the backup.

17. The computer program of claim 13, wherein the one or more verification criteria are automatically determined based on the test specifications.

18. The computer program of claim 12, wherein the instructions comprise communicating the detailed report to a recipient.
